(19) United States
(12) Patent Application Publication
(10) Pub. No.: US 2025/0214105 A1
(43) Pub. Date: Jul. 3, 2025

(54) METHOD FOR MANUFACTURING A VEHICLE PART

(71) Applicant: OPmobility SE, Lyon (FR)

(72) Inventor: Gérald ANDRE, Sainte-Julie (FR)

(73) Assignee: OPmobility SE, Lyon (FR)

(21) Appl. No.: 19/002,828

(22) Filed: Dec. 27, 2024

(30) Foreign Application Priority Data
Dec. 27, 2023 (FR) FR2315395

(51) Int. Cl. B05D 3/06; F21S 41/20; F21S 43/20

(52) U.S. Cl. CPC B05D 3/06; F21S 41/285; F21S 43/255

(57) ABSTRACT

A method for manufacturing a vehicle part includes: applying a paint layer to one face of a transparent or translucent part; and partially irradiating the paint layer with laser radiation so as to etch the paint layer in a predefined pattern and in part of its thickness.

The invention concerns a motor vehicle part. More particularly, the invention relates to a method for manufacturing a transparent vehicle part that contributes to the vehicle's exterior appearance.

A vehicle comprises several transparent parts designed to transmit light. These include in particular parts used for regulatory lighting purposes, such as those protecting the headlamp units of high and low beam headlamps, or blinker lights. Moreover, the vehicle can also feature light sources for decorative purposes that enhance the aesthetics of the vehicle.

To this end, transparent parts can be surface treated to improve their appearance. One way of doing this is to overmold a film onto the surface of the transparent part, the film having a predefined opaque pattern. In this way, when the light source associated with the transparent part emits light, the light is partially blocked by the opacity of the pattern and transmitted by the parts of the part not covered by the pattern. This improves the aesthetics of the light beam transmitted by the transparent part from the light source to the external environment. Another option is to decorate the transparent part with paint and masking, which achieves a similar result.

These options are interesting but can be problematic. In fact, a film as described above or a masking can cause color matching problems with the vehicle's paintwork, which has a negative impact on the vehicle's aesthetics. In addition, film application or masking may not produce a pattern as precise as desired. Moreover, these techniques can pose ageing problems.

To overcome these problems, it is known, for example from document FR 1912347 A1, to apply a coat of paint to a transparent part and then engrave it by laser irradiation in a predefined pattern. This removes the full thickness of the paint layer in the pattern area, allowing light to pass through the transparent part into the pattern area. However, this solution is not entirely satisfactory, as there is still the problem of light passing through those parts of the transparent part that are not covered by the pattern. This is because light is transmitted freely through these parts, so that the elements behind the part are visible from the outside if the light source associated with the transparent part is switched off. These are mainly the light source and possibly wiring elements. It is not good to have these elements visible, as they would detract from the overall appearance of the vehicle, and this should therefore be avoided.

One of the aims of the invention is to remedy these problems by proposing a method which does not pose a problem of color matching with the vehicle's paintwork, which is more precise than that of the prior art, and which makes it possible to conceal the elements located behind the transparent part.

To this end, the invention relates to a method for manufacturing a vehicle part comprising the following steps:
applying a paint layer to one side of a transparent or translucent part, the paint layer being single-coat, and
partially irradiating the paint layer with laser radiation so as to etch the paint layer in a predefined pattern and in part of its thickness.

In this way, the paint can be applied to one side of the transparent part and then partially removed in its thickness by etching with laser radiation in a predefined pattern. In other words, only a residual paint layer remains in the area of the predefined pattern. It is understood that the laser can be used to remove the paint to obtain a more precise rendering than using one of the prior art methods discussed above. Moreover, the fact that the color of the coating is given by paint and not by a film or masking as in the prior art means that a paint can be chosen that matches the one used for the vehicle body. The result is fewer color-matching problems. Furthermore, the manufacturing method involves only one step in applying a coating to the transparent or translucent part, that is, the paint layer, so that the method requires only a single pass through a paint shop or coating line (understood here in the broadest sense). This helps to make the manufacturing method quick and easy to implement and, more generally, more industrially competitive.

The paint layer residue present in the pattern area prevents the transparent or translucent part from being seen through when a light source is associated with the transparent or translucent part and switched off, without preventing the transmission of the light emitted by the light source when it is switched on. This prevents the elements behind the transparent or translucent part from having an impact on the aesthetics of the vehicle, since they are concealed by the layer of paint.

Advantageously, the paint layer is a lacquer layer.

“Lacquer” refers to paint with a hardener. By way of example, the lacquer can be based on thermosetting resins, in particular alkyd or glycerophthalic resins, or based on polyurethanes. Such a lacquer enables a colored finish to be achieved with a coat thickness well below what would be required to achieve such a finish with conventional paint. It should be noted that the lacquer is a synthetic lacquer for industrial use, and is not, in particular, a natural gum-resin, a natural resin or a natural or synthetic varnish. An industrial lacquer is tougher than a conventional paint range, and does not need to be overcoated with a protective varnish.

Advantageously, the paint layer comprises an undercoat of transparent primer. Advantageously, the lacquer layer comprises an undercoat of transparent primer.

Advantageously, the laser radiation has the following parameters: wavelength in the infrared range, working power between 5 and 10 W, scanning speed between 1800 and 2200 mm/s, pulse frequency between 25000 and 35000 Hz.

This makes it possible to etch the paint layer in part of its thickness in a particularly controlled and reproducible way.

Advantageously, the paint layer has a thickness of between 1 and 8 um in the predefined pattern after partial irradiation.

This thickness represents a good compromise between light transmission through the residual paint layer in the pattern area and concealment of the light source when it is switched off.

Advantageously, the transparent or translucent part is manufactured by molding a plastic, e.g., polycarbonate (PC), polypropylene (PP), polyamide (PA), polyethylene terephthalate (PET), polybutylene terephthalate (PBT), polyurethane (PU), polyvinyl chloride (PVC), acrylonitrile butadiene styrene (ABS), styrene acrylonitrile (SAN), acrylonitrile styrene acrylate (ASA), polymethyl methacrylate (PMMA), cycloolefin copolymer (COC) or cycloolefin polymer (COP).

This makes transparent or translucent parts easy and inexpensive to produce.

Advantageously, the paint layer is opaque, preferably black or grey.

The opacity of the paint or lacquer helps to improve the quality of illumination of the pattern produced by a light source positioned behind the vehicle part, thereby preventing the formation of a blurred light halo at the edges of the pattern.

Advantageously, a light source is installed opposite the paint layer.

The paint layer is thus intended to be oriented towards the vehicle interior when the vehicle part is installed in a vehicle. This eliminates the need to protect the paint layer from external damage, such as mechanical stress or ultraviolet radiation from the sun.

The invention also provides for a vehicle part comprising a transparent or translucent part on which a layer of paint is deposited having a first thickness in a predefined pattern and a second thickness outside the predefined pattern, the first thickness being less than the second thickness.

Advantageously, the vehicle part has, in the predefined pattern, a coefficient of haze greater than or equal to 60%, preferably greater than or equal to 75%, for example approximately equal to 80%, more preferably greater than or equal to 90%.

Advantageously, the vehicle part has, in the predefined pattern, a transparency greater than or equal to 20%, preferably greater than or equal to 30%, more preferably between 35% and 45%.

These values represent a good compromise between light transmission through the paint layer in the pattern area and concealment of the light source when it is switched off.

Advantageously, the vehicle part further comprises a light source installed opposite the paint layer. The transparent or translucent part is then designed to protect the light source while allowing partial transmission of the light emitted by the light source.

### BRIEF DESCRIPTION OF THE FIGURES

The invention will be better understood upon reading the following description, which is provided merely as example and with reference to the appended drawings, wherein:

FIG. 1 is a sectional view of a first step in the implementation of a method for manufacturing a vehicle part according to one embodiment of the invention,

FIG. 2 is a sectional view of a second step in the implementation of a method for manufacturing a vehicle part according to one embodiment of the invention, and

FIG. 3 is a sectional view of a third step in the implementation of a method for manufacturing a vehicle part according to one embodiment of the invention.

### DETAILED DESCRIPTION

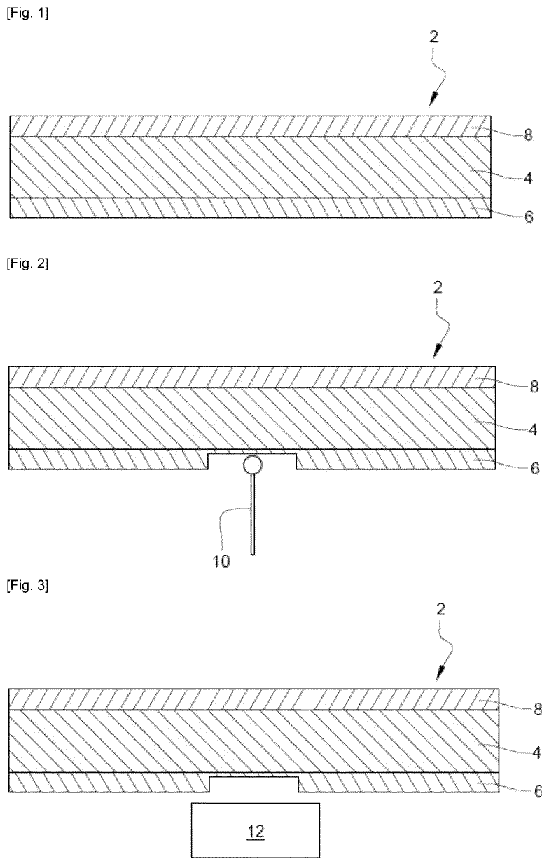

FIG. 1 shows a first step in a method for manufacturing a vehicle part 2 according to one embodiment of the invention.

The vehicle part 2 comprises a transparent or translucent part 4 designed to shield a light source. “Transparent” or “translucent” means that it is at least transparent or translucent to any light radiation with a wavelength in the visible spectrum, that is, between approximately 380 and 780 nm. Here, the part 4 is transparent and made of a plastic with this characteristic, in this case polycarbonate, commonly referred to as “PC”. However, the part can also be made from any other plastic, e.g., polypropylene (PP), polyamide (PA), polyethylene terephthalate (PET), polybutylene terephthalate (PBT), polyurethane (PU), polyvinyl chloride (PVC), acrylonite butadiene styrene (ABS), styrene acrylonitrile (SAN), acrylonitrile styrene acrylate (ASA), polymethyl methacrylate (PMMA), cycloolefin copolymer (COC) or cycloolefin polymer (COP). The transparent or translucent part 4 is produced by molding. As such a method is already known, it will not be described in further detail below.

The vehicle part 2 comprises a paint layer 6 which is deposited on a first side of the transparent or translucent part 4, this first side being intended to face the interior of the vehicle when the vehicle part 2 is installed in a vehicle. The paint layer 6 is single-coat, in the sense that a single product is applied to the part to produce the paint, and it is deposited in a single application. The paint layer used here is a lacquer layer 6, but the invention can be implemented with a “conventional” paint layer. “Lacquer” refers to paint with a hardener. By way of example, the lacquer can be based on thermosetting resins, in particular alkyd or glycerophthalic resins, or based on polyurethanes. It should be noted that the lacquer is a synthetic lacquer for industrial use, and is not, in particular, a natural gum-resin, a natural resin or a natural or synthetic varnish. Here, the lacquer layer 6 is opaque. The preferred color is black or gray. The lacquer layer 6 is approximately 25 μm thick. Optionally, an undercoat of transparent primer is deposited underneath the lacquer layer 6, in which case the undercoat of transparent primer has a thickness of between 25 and 30 μm.

The vehicle part 2 comprises a layer of varnish 8 which is deposited on a second side of the transparent or translucent part 4 opposite the first side. In other words, the varnish layer 8 and the paint layer 6 are deposited on opposite sides of the transparent or translucent part 4. The varnish layer 8 protects the transparent or translucent part 4 from any ultraviolet radiation to which it may be exposed, particularly from the sun. This is particularly advantageous if the transparent or translucent part 4 is made of polycarbonate.

In the first step of the manufacturing method of the vehicle part 2, the varnish layer 8 and the lacquer layer 6 are deposited on the transparent or translucent part 4. The lacquer layer 6 is thick enough to fully absorb any light beam in the visible spectrum. This thickness is between 25 and 50 μm.

FIG. 2 shows a second step in the manufacturing method for the vehicle part 2, which takes place after the first step. In this second step, a portion of the vehicle part 2 is irradiated with laser radiation 10 to etch the lacquer layer 6. This operation is commonly referred to as “laser-etching”. The laser beam 10 has the following parameters: wavelength in the infrared range, operating power between 5 and 10 W, scanning speed between 1800 and 2200 mm/s, pulse frequency between 25000 and 35000 Hz. By way of example, the laser beam 10 has the following parameters: wavelength equal to 1064 nm, operating power equal to 8 W, scanning speed equal to 2000 mm/s, pulse frequency equal to 30000 Hz. Irradiation with the laser beam 10 burns away the lacquer layer 6 in the pattern area, leaving only burnt-on residues of this layer, the laser beam being parameterized to achieve this result. In the pattern area, the residues migrate in part into the transparent or translucent part 4, forming a thin residual layer of lacquer. It is sparse and heterogeneous, with a sparse-grained appearance, so it transmits light diffusely.

Irradiation is carried out only in one part of the vehicle part 2 in the sense that it is carried out according to a predefined pattern formed on the lacquer layer 6. It is controlled so that the lacquer layer 6 is irradiated in the pattern but only in part of its thickness, but not the transparent or translucent part 4. If present, the transparent primer undercoat protects the transparent or translucent part 4 from the heat effect of the laser radiation 10 by creating a separation distance between the irradiated lacquer layer 6 and the transparent or translucent part 4. Indeed, it has been observed that the transparent or translucent part 4 tends to yellow, particularly if it is made from polycarbonate, under the effect of the laser radiation 10 without the presence of the primer undercoat.

After irradiation, the lacquer layer 6 has two levels.

In the area of the predefined pattern, the lacquer layer 6 is present in a first thickness equal to a fraction of its original thickness, here between 1 and 8 μm. Therefore, it is the single layer itself, forming the lacquer layer 6, that is etched. In this area, the vehicle part 2 has a coefficient of haze greater than or equal to 60%, preferably greater than or equal to 75% and more preferably greater than 90%, and has a transparency greater than or equal to 20%, preferably greater than or equal to 30% and more preferably between 35% and 45% (ideally equal to 40%).

Outside the area of the predefined pattern, the lacquer layer 6 is intact and has a second thickness equal to the thickness of the lacquer layer 6 as deposited. The first thickness is therefore less than the second.

After the irradiation step, an additional polishing step can be performed

on the transparent or translucent part 4. This improves transparency in the area of the predefined pattern and, more generally, the aesthetics of the vehicle part 2. Furthermore, this polishing also rounds off the corners formed by the etching carried out during the irradiation step, and thus attenuates light scattering phenomena that could disrupt a light beam passing through the vehicle part 2.

FIG. 3 shows a third step in the manufacturing method for the vehicle part 2. In this step, which takes place after the irradiation step, a light source 12 is associated with the transparent or translucent part 4. Here, the light source 12 is installed opposite the lacquer layer 6, so that the latter faces the vehicle interior when the vehicle part 2 is installed in a vehicle. In other words, the lacquer layer 6 is deposited on the side of the transparent or translucent part 4 (first side) opposite the side of the transparent or translucent part 4 visible from the outside (second side) when the vehicle part 2 is installed in the vehicle. This configuration is generally referred to as the “B-side” of the lacquer layer 6. The varnish layer 8 is deposited on the A-side. In this way, the first and second sides previously introduced correspond to B-side and A-side, respectively.

When the light source 12 is switched off, so that it does not emit light, it is not visible through the transparent or translucent part 4 due to the presence of the lacquer layer 6, over its full thickness outside the pattern area and over the partial thickness in the pattern area.

When the light source 12 is switched on so that it emits light in the direction of the transparent or translucent part 4, the light is transmitted through the partial lacquer layer 6 into the pattern area and blocked by the lacquer layer 6 outside the pattern area. Because the lacquer layer 6 is opaque, and also black or gray, it does little or nothing to alter the color of the transmitted light, and light transmission takes place without the formation of a blurred luminous halo at the edges of the pattern area.

The invention is not limited to the embodiments presented, and other embodiments will become clearly apparent to the person skilled in the art.

The light source can be part of a vehicle's low-beam and high-beam headlamp units, a vehicle's turn signal headlamp unit, or a decorative headlamp unit.

The paint or lacquer can be made from a colored material. In this way, the scattering of light emitted by the light source through the partial lacquer layer is accompanied by light coloration, giving it a certain aesthetic effect.

Alternatively, the paint or lacquer layer can be deposited on the A-side of the transparent or translucent part. In this case, the varnish layer is deposited on top of the paint or lacquer layer, and the B-side of the transparent or translucent part, in front of which the light source is placed, can be left bare.

### LIST OF REFERENCES

2: vehicle part
4: transparent or translucent part
6: paint/lacquer layer
8: coat of varnish
10: laser radiation
12: light source

1. A method of manufacturing a vehicle part, comprising:
applying a paint layer to one side of a transparent or translucent part, the paint layer being single-coated, and
partially irradiating the paint layer with laser radiation so as to etch the paint layer (6) in a predefined pattern and in part of its thickness.

2. The method according to claim 1, wherein the paint layer is a lacquer layer.

3. The method according to claim 1, wherein the laser radiation has the following parameters: wavelength in the infrared range, operating power between 5 and 10 W, scanning speed between 1800 and 2200 mm/s, pulse frequency between 25000 and 35000 Hz.

4. The method according to claim 1, wherein the paint layer has a thickness of between 1 and 8 μm in the predefined pattern after the partial irradiation.

5. The method according to claim 1, wherein the transparent or translucent part is manufactured by molding a plastic, e.g., polycarbonate, polypropylene, polyamide, polyethylene terephthalate, polybutylene terephthalate, polyurethane, polyvinyl chloride, acrylonitrile butadiene styrene, styrene acrilonitrile, acrylonitrile styrene acrylate, polymethyl methacrylate, cycloolefin copolymer or cycloolefin polymer.

6. The method according to claim 1, wherein the paint layer is opaque, and preferably black or gray in color.

7. The method according to claim 1, wherein a light source is installed opposite the paint layer.

8. A vehicle part, comprising a transparent or translucent part on which is deposited a paint layer having a first thickness in a predefined pattern and a second thickness outside the predefined pattern, the first thickness being less than the second thickness.

9. The vehicle part according to claim 8, having a coefficient of Haze in the predefined pattern greater than or equal to 60%, preferably greater than or equal to 75%, more preferably greater than or equal to 90%.

10. The vehicle part according to claim 8, having a transparency in the predefined pattern greater than or equal to 20%, preferably greater than or equal to 30%, more preferably between 35% and 45%.

11. The vehicle part according to claim 8, further comprising a light source installed opposite the paint layer.
